(19) United States
(12) Patent Application Publication
(10) Pub. No.: US 2020/0366407 A1
(43) Pub. Date: Nov. 19, 2020

(54) CAPABILITY-BASED BANDWIDTH PART SWITCHING

(71) Applicant: QUALCOMM Incorporated, San Diego, CA (US)

(72) Inventors: Sagar LNU, Hyderabad (IN); Venkata A Naidu BABBADI, Hyderabad (IN); Avinash Kumar Dubey, Hyderabad (IN)

(21) Appl. No.: 16/413,371

(22) Filed: May 15, 2019

(51) Int. Cl. H04L 1/00; H04W 8/24; H04W 24/10; H04B 7/06; H04L 5/00; H04W 72/04; H04B 7/0417

(52) U.S. Cl. CPC H04L 1/0026; H04W 8/24; H04W 24/10; H04B 7/0626; H04B 7/0417; H04L 5/0048; H04L 5/0055; H04W 72/0453; H04L 1/0027

(57) ABSTRACT

Various aspects of the present disclosure generally relate to wireless communication. In some aspects, a user equipment (UE) may transmit information identifying one or more capabilities of the UE in connection with an inactive bandwidth part (BWP) of the UE, wherein the one or more capabilities include at least one of a gapless channel state information (CSI) measurement capability or a gapless reference signal transmission capability. The UE may perform at least one of a CSI measurement or a reference signal transmission on the inactive BWP in accordance with the one or more capabilities. Numerous other aspects are provided.

### FIELD OF THE DISCLOSURE

Aspects of the present disclosure generally relate to wireless communication and to techniques and apparatuses for capability-based bandwidth part switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipments (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, further improvements in LTE and NR technologies continue to be useful. Preferably, these improvements should be applicable to other multiple access technologies and the telecommunication standards that employ these technologies.

### SUMMARY

In some aspects, a method of wireless communication, performed by a UE, may include transmitting information identifying one or more capabilities of the UE in connection with an inactive bandwidth part (BWP) of the UE, wherein the one or more capabilities include at least one of a gapless channel state information (CSI) measurement capability or a gapless reference signal transmission capability; and performing at least one of a CSI measurement or a reference signal transmission on the inactive BWP in accordance with the one or more capabilities.

In some aspects, a method of wireless communication, performed by a base station, may include receiving information identifying one or more capabilities of a UE, wherein the one or more capabilities include at least one of a gapless CSI measurement capability or a gapless reference signal transmission capability; and transmitting configuration information for performing at least one of a CSI measurement or a reference signal transmission on an inactive BWP of the UE in accordance with the one or more capabilities.

In some aspects, a UE for wireless communication may include memory and one or more processors operatively coupled to the memory. The memory and the one or more processors may be configured to transmit information identifying one or more capabilities of the UE in connection with an inactive BWP of the UE, wherein the one or more capabilities include at least one of a gapless CSI measurement capability or a gapless reference signal transmission capability; and perform at least one of a CSI measurement or a reference signal transmission on the inactive BWP in accordance with the one or more capabilities.

In some aspects, a base station for wireless communication may include memory and one or more processors operatively coupled to the memory. The memory and the one or more processors may be configured to receive information identifying one or more capabilities of a UE, wherein the one or more capabilities include at least one of a gapless CSI measurement capability or a gapless reference signal transmission capability; and transmit configuration information for performing at least one of a CSI measurement or a reference signal transmission on an inactive BWP of the UE in accordance with the one or more capabilities.

In some aspects, a non-transitory computer-readable medium may store one or more instructions for wireless communication. The one or more instructions, when executed by one or more processors of a UE, may cause the one or more processors to: transmit information identifying one or more capabilities of the UE in connection with an inactive BWP of the UE, wherein the one or more capabilities include at least one of a gapless CSI measurement capability or a gapless reference signal transmission capability; and perform at least one of a CSI measurement or a reference signal transmission on the inactive BWP in accordance with the one or more capabilities.

In some aspects, a non-transitory computer-readable medium may store one or more instructions for wireless communication. The one or more instructions, when executed by one or more processors of a base station, may cause the one or more processors to: receive information identifying one or more capabilities of a UE, wherein the one or more capabilities include at least one of a gapless CSI measurement capability or a gapless reference signal transmission capability; and transmit configuration information for performing at least one of a CSI measurement or a reference signal transmission on an inactive BWP of the UE in accordance with the one or more capabilities.

In some aspects, an apparatus for wireless communication may include means for transmitting information identifying one or more capabilities of the apparatus in connection with an inactive BWP of the apparatus, wherein the one or more capabilities include at least one of a gapless CSI measurement capability or a gapless reference signal transmission capability; and means for performing at least one of a CSI measurement or a reference signal transmission on the inactive BWP in accordance with the one or more capabilities.

In some aspects, an apparatus for wireless communication may include means for receiving information identifying one or more capabilities of a UE, wherein the one or more capabilities include at least one of a gapless CSI measurement capability or a gapless reference signal transmission capability; and means for transmitting configuration information for performing at least one of a CSI measurement or a reference signal transmission on an inactive BWP of the UE in accordance with the one or more capabilities.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of capability-based bandwidth part switching for a UE capable of gapless measurement or reference signaling, in accordance with various aspects of the present disclosure.

FIG. 4 is a diagram illustrating an example of capability-based bandwidth part switching for a UE incapable of gapless measurement or reference signaling, in accordance with various aspects of the present disclosure.

FIG. 5 is a diagram illustrating an example process performed, for example, by a user equipment, in accordance with various aspects of the present disclosure.

FIG. 6 is a diagram illustrating an example process performed, for example, by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

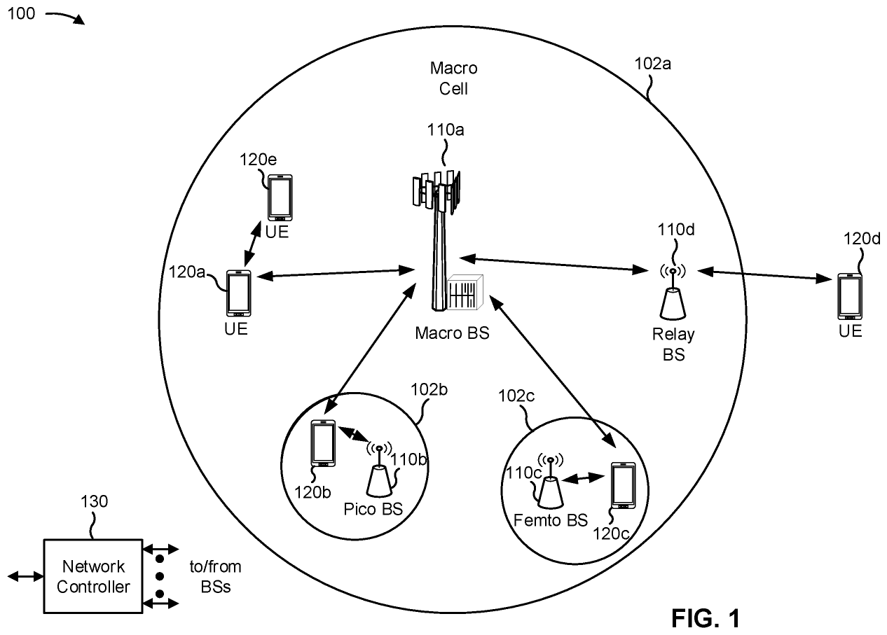

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

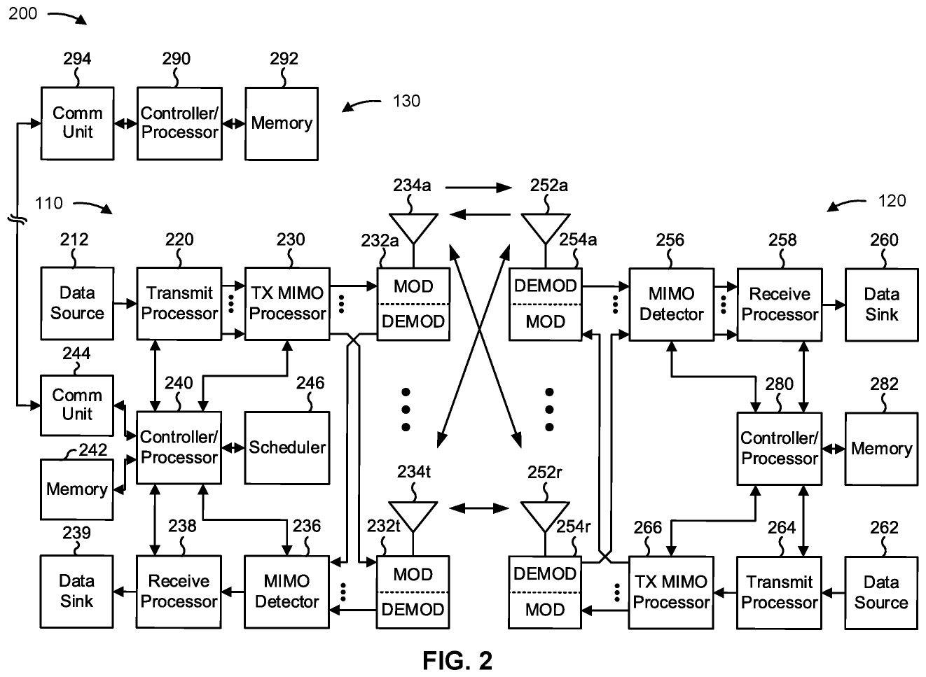

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

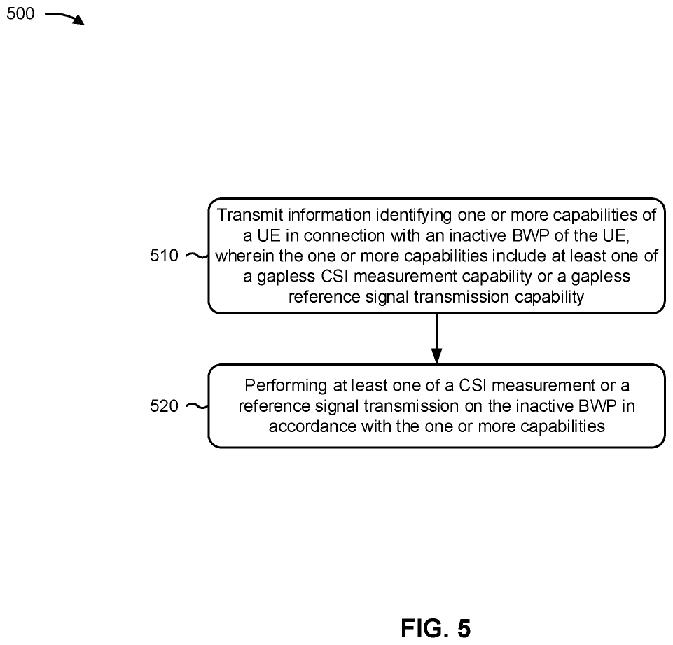

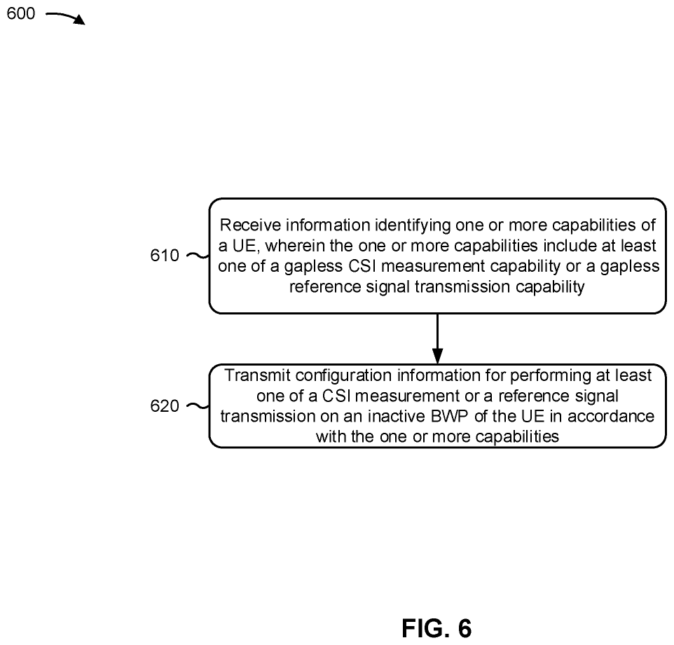

Controller/processor 240 of base station 110, controller/processor 280 of UE 120, and/or any other component(s) of FIG. 2 may perform one or more techniques associated with capability-based bandwidth part switching, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for transmitting information identifying one or more capabilities of the UE in connection with an inactive bandwidth part (BWP) of the UE, wherein the one or more capabilities include at least one of a gapless channel state information (CSI) measurement capability or a gapless reference signal transmission capability (which may, but not necessarily, include, for example, controller/processor 280, transmit processor 264, TX MIMO processor 266, MOD 254, antenna 252, and/or the like); means for performing at least one of a CSI measurement or a reference signal transmission on the inactive BWP in accordance with the one or more capabilities (which may, but not necessarily, include, for example, antenna 252, DEMOD 254, MIMO detector 256, receive processor 258, controller/processor 280, transmit processor 264, TX MIMO processor 266, MOD 254, and/or the like); means for receiving configuration information for performing the CSI measurement on the inactive BWP in accordance with the one or more capabilities (which may, but not necessarily, include, for example, antenna 252, DEMOD 254, MIMO detector 256, receive processor 258, controller/processor 280, transmit processor 264, TX MIMO processor 266, MOD 254, and/or the like); means for transmitting, on an active BWP of the UE, a CSI report based at least in part on the CSI measurement on the inactive BWP (which may, but not necessarily, include, for example, controller/processor 280, transmit processor 264, TX MIMO processor 266, MOD 254, antenna 252, and/or the like); means for receiving configuration information for performing the reference signal transmission on the inactive BWP in accordance with the one or more capabilities (which may, but not necessarily, include, for example, antenna 252, DEMOD 254, MIMO detector 256, receive processor 258, controller/processor 280, and/or the like); means for performing the CSI measurement without a gap on an active BWP of the UE when the gapless CSI measurement capability indicates that the UE is capable of performing the CSI measurement without the gap on the active BWP of the UE (which may, but not necessarily, include, for example, antenna 252, DEMOD 254, MIMO detector 256, receive processor 258, controller/processor 280, and/or the like); means for performing the reference signal transmission without a gap on an active BWP of the UE when the gapless reference signal transmission capability indicates that the UE is capable of performing the reference signal transmission without the gap on the active BWP of the UE (which may, but not necessarily, include, for example, antenna 252, DEMOD 254, MIMO detector 256, receive processor 258, controller/processor 280, and/or the like); means for performing the CSI measurement with a gap on an active BWP of the UE when the gapless CSI measurement capability indicates that the UE is not capable of performing the CSI measurement without the gap on the active BWP of the UE (which may, but not necessarily, include, for example, antenna 252, DEMOD 254, MIMO detector 256, receive processor 258, controller/processor 280, and/or the like); means for performing the reference signal transmission with a gap on an active BWP of the UE when the gapless reference signal transmission capability indicates that the UE is not capable of performing the reference signal transmission without the gap on the active BWP of the UE (which may, but not necessarily, include, for example, antenna 252, DEMOD 254, MIMO detector 256, receive processor 258, controller/processor 280, and/or the like); and/or the like. In some aspects, such means may include one or more components of UE 120 described in connection with FIG. 2.

In some aspects, base station 110 may include means for receiving information identifying one or more capabilities of a UE, wherein the one or more capabilities include at least one of a gapless CSI measurement capability or a gapless reference signal transmission capability (which may, but not necessarily, include, for example, antenna 234, DEMOD 232, MIMO detector 236, receive processor 238, controller/processor 240, and/or the like); means for transmitting configuration information for performing at least one of a CSI measurement or a reference signal transmission on an inactive BWP of the UE in accordance with the one or more capabilities (which may, but not necessarily, include, for example, controller/processor 240, transmit processor 220, TX MIMO processor 230, MOD 232, antenna 234, and/or the like); means for receiving, on an active BWP associated with the UE, a CSI report based at least in part on the CSI measurement on the inactive BWP (which may, but not necessarily, include, for example, antenna 234, DEMOD 232, MIMO detector 236, receive processor 238, controller/processor 240, and/or the like); means for configuring the UE to switch the inactive BWP to an active BWP of the UE (which may, but not necessarily, include, for example, controller/processor 240, transmit processor 220, TX MIMO processor 230, MOD 232, antenna 234, and/or the like); and/or the like. In some aspects, such means may include one or more components of base station 110 described in connection with FIG. 2.

As indicated above, FIG. 2 is provided as an example. Other examples may differ from what is described with regard to FIG. 2.

A UE may be configured with a bandwidth part (BWP) on which the UE is to operate. A bandwidth part is a segment of a carrier. The usage of BWPs may provide efficient bandwidth utilization and may support the deployment of UEs with different capabilities, bandwidth needs, power management requirements, and so on. In some cases, a UE may be configured with an active BWP, which is a BWP that the UE is to monitor, and one or more other BWPs (referred to as inactive BWPs). In some cases, the UE only performs CSI measurement and reference signal (RS) transmission on the active bandwidth part.

The network (e.g., BS 110, network controller 130, and/or the like) can instruct the UE to switch to a new active BWP, of the BWPs configured for the UE. For example, the network may transmit downlink control information (DCI) on a downlink control channel, a media access control (MAC) control element (CE), and/or the like, indicating that the UE is to switch to the new active BWP. However, if the UE only performs CSI measurement and RS signaling on the original active BWP, then the network may not know channel conditions on the new active BWP. This may result in a drop in throughput until the network receives CSI feedback and/or reference signaling for the new active BWP, or may lead to the UE switching to yet another active BWP (if channel conditions are poor), thereby further reducing throughput and increasing overhead.

Some techniques and apparatuses described herein provide inactive-BWP reference signaling and/or CSI measurement based at least in part on a UE capability. For example, the UE may provide information indicating one or more capabilities (e.g., a gapless CSI measurement capability on an inactive BWP and/or a gapless RS transmission capability on an inactive BWP) to a BS. The BS may instruct the UE to perform a CSI measurement and/or an RS transmission on an inactive BWP in a gapless fashion when the one or more capabilities indicate that the UE is capable of doing so, or may configure a CSI measurement and/or an RS transmission on the inactive BWP using a gap when the UE is not capable of gapless CSI measurement or RS transmission. Thus, the BS and the UE may provide CSI feedback and/or RS transmission on inactive BWPs, thereby enabling more efficient BWP switching. Furthermore, by performing CSI feedback and/or RS transmission based at least in part on UE capabilities, techniques and apparatuses described herein may increase the number of UEs that can support inactive-BWP reference signaling or CSI feedback.

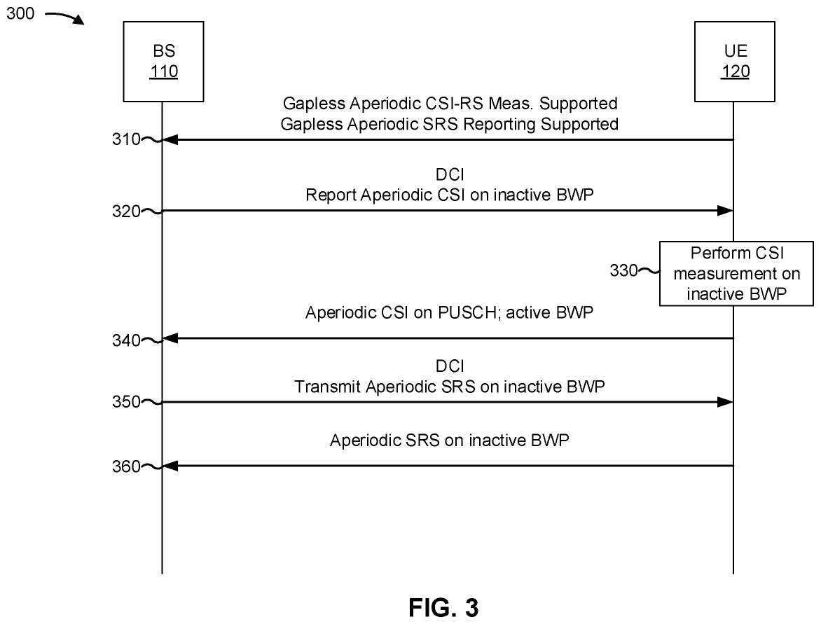

FIG. 3 is a diagram illustrating an example 300 of capability-based bandwidth part switching for a UE capable of gapless measurement or reference signaling, in accordance with various aspects of the present disclosure. As shown, example 300 includes a BS 110 and a UE 120. In example 300, the BS 110 (or another network device) has configured the UE 120 with an active BWP and at least one inactive BWP.

As shown by reference number 310, the UE 120 may transmit information identifying one or more capabilities to the BS 110. For example, the information identifying the one or more capabilities may include capability information, such as UE capability information and/or the like. As shown, the one or more capabilities may include a gapless CSI-RS measurement capability and a gapless RS transmission capability, or more particularly, a gapless aperiodic CSI-RS measurement capability and a gapless aperiodic SRS reporting capability. The gapless CSI measurement capability may indicate whether the UE 120 is capable of measuring CSI on an inactive BWP without a gap for tuning to and from the inactive BWP. The gapless RS transmission capability may indicate whether the UE 120 is capable of transmitting an RS, such as a sounding RS (SRS) and/or the like on an inactive BWP without a gap for tuning to and from the inactive BWP.

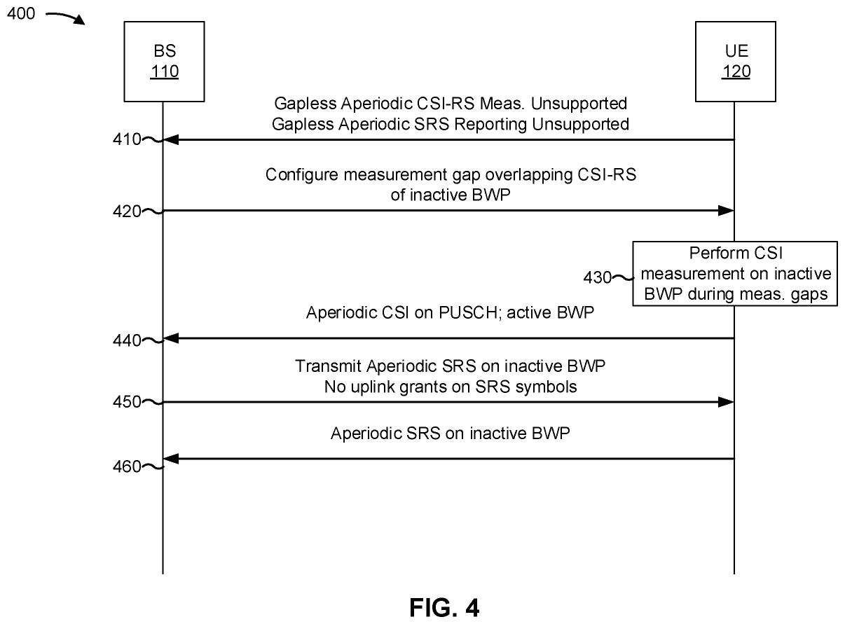

The UE may support these capabilities based at least in part on a radio frequency (RF) capability of the UE 120. For example, when the UE 120 is capable of receiving or transmitting on a bandwidth sufficiently wide to include the active BWP of the UE 120 and the inactive BWP of the UE 120 without returning an RF chain of the UE 120, then the UE 120 may signal that the UE 120 is capable of gapless CSI measurement and/or gapless RS measurement. This may be dependent on the capabilities of various components of the UE 120, such as a low noise amplifier, a mixer, an analog filter, and/or the like (which may, in some examples, be components within antenna 252, DEMOD 254, MOD 254, and/or in between antenna 252 and DEMOD/MOD 254). In this case, the UE 120 signals that the UE 120 is capable of gapless CSI measurement and gapless RS transmission. In some aspects, the UE 120 may signal that the UE 120 is capable of neither gapless CSI measurement nor gapless RS transmission (as described in connection with FIG. 4), or that the UE 120 is capable of only one of gapless CSI measurement or gapless RS transmission, depending upon the transmission and reception capabilities of the UE 120 and/or other factors.

As shown by reference number 320, the BS 110 may transmit information indicating to report CSI (e.g., to perform a CSI measurement and/or to report CSI feedback based at least in part on the CSI measurement on the inactive BWP) on an inactive BWP of the UE 120. In this case, the BS 110 may provide this information in the form of DCI, though any form of information may be used. In some aspects, the information indicating to report the CSI may identify the inactive BWP, may identify a time and/or resource associated with the CSI, may identify a CSI signal that the UE 120 is to monitor, and/or the like.

As shown by reference number 330, the UE 120 may perform the CSI measurement on the inactive BWP. For example, the UE 120 may perform the CSI measurement without a gap because the RF chain of the UE 120 is capable of tuning to the complete operating bandwidth of the UE 120, as indicated by the gapless aperiodic CSI-RS measurement capability. Thus, the UE 120 may determine CSI for the inactive BWP without the interruption to the operation of the UE 120 that would occur when using a measurement gap.

As shown by reference number 340, the UE 120 may transmit an aperiodic CSI report. For example, the UE 120 may transmit the aperiodic CSI report using a physical uplink shared channel (PUSCH). The aperiodic CSI report may indicate CSI feedback based at least in part on the UE 120's CSI measurement on the inactive BWP. In some aspects, the UE 120 may transmit the aperiodic CSI report on the active BWP of the UE 120. In some aspects, the UE 120 may transmit the aperiodic CSI report on an inactive BWP of the UE 120 (e.g., if the active BWP is heavily trafficked, if channel conditions on the inactive BWP satisfy a threshold, etc.).

As shown by reference number 350, the BS 110 may transmit information indicating that the UE 120 is to transmit an RS on the inactive BWP. Here, the RS is an aperiodic SRS. As shown by reference number 360, the UE 120 may transmit the RS on the inactive BWP. For example, the UE 120 may transmit the aperiodic SRS on the inactive BWP, since the UE 120 is capable of tuning to the bandwidth of the inactive BWP and transmitting the aperiodic SRS without a gap. In some aspects, the BS 110 may determine whether the UE 120 is to be switched to the inactive BWP based at least in part on the CSI report and/or the SRS, and, when the BS 110 determines that the UE 120 is to be switched to the inactive BWP as an active BWP, the BS 110 may configure the UE 120 to switch to the inactive BWP.

While the above operations are described with reference to a single inactive BWP, the above operations may be similarly applied for multiple inactive BWPs. For example, the BS 110 may provide information indicating that the UE 120 is to perform CSI measurement and/or RS transmission on multiple inactive BWPs, and the UE 120 may act accordingly.

As indicated above, FIG. 3 is provided as an example. Other examples may differ from what is described with respect to FIG. 3.

FIG. 4 is a diagram illustrating an example 400 of capability-based bandwidth part switching for a UE incapable of gapless measurement or reference signaling, in accordance with various aspects of the present disclosure.

As shown by reference number 410, the UE 120 may provide capability information indicating that the UE 120 is not capable of gapless CSI measurement or gapless RS transmission. This may be due to an RF chain limitation of the UE 120. Accordingly, as shown by reference number 420, the BS 110 may configure a measurement gap for the UE 120. The measurement gap may be in an active BWP of the UE 120, and may overlap a CSI-RS of the inactive BWP. This may provide the UE 120 with the time needed to tune to the inactive BWP and perform the CSI measurement. In some aspects, the BS 110 may configure multiple measurement gaps (e.g., when the UE 120 is to perform measurement of multiple CSI-RS).

As shown by reference number 430, the UE 120 may tune to the inactive BWP, and may perform the CSI measurement on the inactive BWP during the measurement gaps. Thus, the UE 120 may determine CSI feedback for an inactive BWP despite the UE 120 signaling that the UE 120 is incapable of gapless CSI-RS measurement on an inactive BWP. As shown by reference number 440, the UE 120 may transmit the CSI feedback associated with the CSI measurement (e.g., the aperiodic CSI measurement) using a PUSCH and/or on an active BWP of the UE 120.

As shown by reference number 450, the BS 110 may configure the UE 120 to transmit an RS (e.g., an aperiodic SRS and/or the like) on an inactive BWP of the UE 120. Furthermore, as shown, the BS 110 may provide no uplink grants, acknowledgments (ACKs)/negative ACKs (NACKs), and/or the like for the active BWP on symbols that collide with symbols used to transmit the SRS. In some aspects, the BS 110 may not provide uplink grants for one or more symbols around symbols used to transmit the SRS (e.g., so that the UE 120 has a gap to tune to and from the inactive BWP). As shown by reference number 460, the UE 120 may transmit the SRS in the gap provided by the BS 110. In this way, the BS 110 provides a gap for the UE 120 to transmit an SRS on an inactive BWP when the UE 120 is incapable of gapless RS transmission on the inactive BWP.

As indicated above, FIG. 4 is provided as an example. Other examples may differ from what is described with respect to FIG. 4.

FIG. 5 is a diagram illustrating an example process 500 performed, for example, by a user equipment, in accordance with various aspects of the present disclosure. Example process 500 is an example where a UE (e.g., user equipment 120 and/or the like) performs operations associated with capability-based bandwidth part switching.

As shown in FIG. 5, in some aspects, process 500 may include transmitting information identifying (e.g., indicating) one or more capabilities of the UE in connection with an inactive BWP of the UE, wherein the one or more capabilities include at least one of a gapless CSI measurement capability or a gapless reference signal transmission capability (block 510). For example, the UE (e.g., using controller/processor 280, transmit processor 264, TX MIMO processor 266, MOD 254, antenna 252, and/or the like) may transmit information identifying one or more capabilities of the UE in connection with an inactive BWP of the UE, as described above. In some aspects, the one or more capabilities include at least one of a gapless CSI measurement capability and/or a gapless reference signal transmission capability. Hence, the information identifying or indicating one or more capabilities of the UE can be information identifying a gapless CSI measurement capability of the UE, a gapless reference signal transmission capability of the UE, or both a gapless CSI measurement capability of the UE and a gapless reference signal transmission capability of the UE.

As further shown in FIG. 5, in some aspects, process 500 may include performing at least one of a CSI measurement or a reference signal transmission on the inactive BWP in accordance with the one or more capabilities (block 520). For example, the UE (e.g., using antenna 252, DEMOD 254, MIMO detector 256, receive processor 258, controller/processor 280, transmit processor 264, TX MIMO processor 266, MOD 254, and/or the like) may perform at least one of a CSI measurement or a reference signal transmission on the inactive BWP in accordance with the one or more capabilities, as described above.

Process 500 may include additional aspects, such as any single aspect or any combination of aspects described below and/or in connection with one or more other processes described elsewhere herein.

In a first aspect, the gapless CSI measurement capability indicates whether the UE is capable of performing the CSI measurement on the inactive BWP without a gap on an active BWP of the UE.

In a second aspect, alone or in combination with the first aspect, the gapless reference signal transmission capability indicates whether the UE is capable of performing the reference signal transmission on the inactive BWP without a gap on an active BWP of the UE.

In a third aspect, alone or in combination with one or more of the first and second aspects, the information identifying the one or more capabilities comprises capability information.

In a fourth aspect, alone or in combination with one or more of the first through third aspects, the UE may receive configuration information for performing the CSI measurement on the inactive BWP in accordance with the one or more capabilities.

In a fifth aspect, alone or in combination with one or more of the first through fourth aspects, the UE may transmit, on an active BWP of the UE, a CSI report based at least in part on the CSI measurement on the inactive BWP.

In a sixth aspect, alone or in combination with one or more of the first through fifth aspects, the UE may receive configuration information for performing the reference signal transmission on the inactive BWP in accordance with the one or more capabilities.

In a seventh aspect, alone or in combination with one or more of the first through sixth aspects, performing at least one of the CSI measurement or the reference signal transmission on the inactive BWP in accordance with the one or more capabilities further comprises performing the CSI measurement on the inactive BWP without a gap on an active BWP of the UE when the gapless CSI measurement capability indicates that the UE is capable of performing the CSI measurement on the inactive BWP without the gap on the active BWP of the UE.

In an eighth aspect, alone or in combination with one or more of the first through seventh aspects, performing at least one of the CSI measurement or the reference signal transmission on the inactive BWP in accordance with the one or more capabilities further comprises performing the reference signal transmission on the inactive BWP without a gap on an active BWP of the UE when the gapless reference signal transmission capability indicates that the UE is capable of performing the reference signal transmission on the inactive BWP without the gap on the active BWP of the UE.

In a ninth aspect, alone or in combination with one or more of the first through eighth aspects, performing at least one of the CSI measurement or the reference signal transmission on the inactive BWP in accordance with the one or more capabilities further comprises performing the CSI measurement on the inactive BWP with a gap on an active BWP of the UE when the gapless CSI measurement capability indicates that the UE is not capable of performing the CSI measurement on the inactive BWP without the gap on the active BWP of the UE.

In a tenth aspect, alone or in combination with one or more of the first through ninth aspects, performing at least one of the CSI measurement or the reference signal transmission on the inactive BWP in accordance with the one or more capabilities further comprises performing the reference signal transmission on the inactive BWP with a gap on an active BWP of the UE when the gapless reference signal transmission capability indicates that the UE is not capable of performing the reference signal transmission on the inactive BWP without the gap on the active BWP of the UE.

In an eleventh aspect, alone or in combination with one or more of the first through tenth aspects, the one or more capabilities are based at least in part on a tunable bandwidth of the UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with various aspects of the present disclosure. Example process 600 is an example where a base station (e.g., base station 110 and/or the like) performs operations associated with capability-based bandwidth part switching.

As shown in FIG. 6, in some aspects, process 600 may include receiving information identifying one or more capabilities of a UE, wherein the one or more capabilities include at least one of a gapless CSI measurement capability or a gapless reference signal transmission capability (block 610). For example, the base station (e.g., using antenna 234, DEMOD 232, MIMO detector 236, receive processor 238, controller/processor 240, and/or the like) may receive information identifying one or more capabilities of a UE, as described above. In some aspects, the one or more capabilities include at least one of a gapless CSI measurement capability or a gapless reference signal transmission capability.

As further shown in FIG. 6, in some aspects, process 600 may include transmitting configuration information for performing at least one of a CSI measurement or a reference signal transmission on an inactive BWP of the UE in accordance with the one or more capabilities (block 620). For example, the base station (e.g., using controller/processor 240, transmit processor 220, TX MIMO processor 230, MOD 232, antenna 234, and/or the like) may transmit configuration information for performing at least one of a CSI measurement or a reference signal transmission on an inactive BWP of the UE in accordance with the one or more capabilities, as described above.

Process 600 may include additional aspects, such as any single aspect or any combination of aspects described below and/or in connection with one or more other processes described elsewhere herein.

In a first aspect, the gapless CSI measurement capability indicates whether the UE is capable of performing the CSI measurement on the inactive BWP without a gap on an active BWP of the UE.

In a second aspect, alone or in combination with the first aspect, the gapless reference signal transmission capability indicates whether the UE is capable of performing the reference signal transmission on the inactive BWP without a gap on an active BWP of the UE.

In a third aspect, alone or in combination with one or more of the first and second aspects, the information identifying the one or more capabilities comprises capability information.

In a fourth aspect, alone or in combination with one or more of the first through third aspects, the base station may receive, on an active BWP associated with the UE, a CSI report based at least in part on the CSI measurement on the inactive BWP.

In a fifth aspect, alone or in combination with one or more of the first through fourth aspects, the configuration information indicates to perform the CSI measurement on the inactive BWP without a gap on an active BWP of the UE when the gapless CSI measurement capability indicates that the UE is capable of performing the CSI measurement on the inactive BWP without the gap on the active BWP of the UE.

In a sixth aspect, alone or in combination with one or more of the first through fifth aspects, the configuration information indicates to perform the reference signal transmission on the inactive BWP without a gap on an active BWP of the UE when the gapless reference signal transmission capability indicates that the UE is capable of performing the reference signal transmission on the inactive BWP without the gap on the active BWP of the UE.

In a seventh aspect, alone or in combination with one or more of the first through sixth aspects, the configuration information indicates to perform the CSI measurement on the inactive BWP with a gap on an active BWP of the UE when the gapless CSI measurement capability indicates that the UE is not capable of performing the CSI measurement on the inactive BWP without the gap on the active BWP of the UE.

In an eighth aspect, alone or in combination with one or more of the first through seventh aspects, an uplink grant or acknowledgment (ACK)/negative ACK (NACK) is not configured on an active BWP of the UE in a symbol associated with the reference signal transmission when the gapless reference signal transmission capability indicates that the UE is not capable of performing the reference signal transmission on the inactive BWP without a gap on the active BWP of the UE.

In a ninth aspect, alone or in combination with one or more of the first through eighth aspects, the base station may configure the UE to switch the inactive BWP to an active BWP of the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
transmitting information identifying one or more capabilities of the UE in connection with an inactive bandwidth part (BWP) of the UE, wherein the one or more capabilities include at least one of a gapless channel state information (CSI) measurement capability or a gapless reference signal transmission capability; and
performing at least one of a CSI measurement or a reference signal transmission on the inactive BWP in accordance with the one or more capabilities.

2. The method of claim 1, further comprising:
receiving configuration information for performing the CSI measurement on the inactive BWP in accordance with the one or more capabilities.

3. The method of claim 1, further comprising:
transmitting, on an active BWP of the UE, a CSI report based at least in part on the CSI measurement on the inactive BWP.

4. The method of claim 1, further comprising:
receiving configuration information for performing the reference signal transmission on the inactive BWP in accordance with the one or more capabilities.

5. The method of claim 1, wherein performing at least one of the CSI measurement or the reference signal transmission on the inactive BWP in accordance with the one or more capabilities further comprises:
performing the CSI measurement on the inactive BWP without a gap on an active BWP of the UE when the gapless CSI measurement capability indicates that the UE is capable of performing the CSI measurement on the inactive BWP without the gap on the active BWP of the UE.

6. The method of claim 1, wherein performing at least one of the CSI measurement or the reference signal transmission on the inactive BWP in accordance with the one or more capabilities further comprises:
performing the reference signal transmission on the inactive BWP without a gap on an active BWP of the UE when the gapless reference signal transmission capability indicates that the UE is capable of performing the reference signal transmission on the inactive BWP without the gap on the active BWP of the UE.

7. The method of claim 1, wherein performing at least one of the CSI measurement or the reference signal transmission on the inactive BWP in accordance with the one or more capabilities further comprises:
performing the CSI measurement on the inactive BWP with a gap on an active BWP of the UE when the gapless CSI measurement capability indicates that the UE is not capable of performing the CSI measurement on the inactive BWP without the gap on the active BWP of the UE.

8. The method of claim 1, wherein performing at least one of the CSI measurement or the reference signal transmission on the inactive BWP in accordance with the one or more capabilities further comprises:
performing the reference signal transmission on the inactive BWP with a gap on an active BWP of the UE when the gapless reference signal transmission capability indicates that the UE is not capable of performing the reference signal transmission on the inactive BWP without the gap on the active BWP of the UE.

9. The method of claim 1, wherein the one or more capabilities are based at least in part on a tunable bandwidth of the UE.

10. A method of wireless communication performed by a base station, comprising:
receiving information identifying one or more capabilities of a user equipment (UE), wherein the one or more capabilities include at least one of a gapless channel state information (CSI) measurement capability or a gapless reference signal transmission capability; and
transmitting configuration information for performing at least one of a CSI measurement or a reference signal transmission on an inactive BWP of the UE in accordance with the one or more capabilities.

11. The method of claim 10, further comprising:
receiving, on an active BWP associated with the UE, a CSI report based at least in part on the CSI measurement on the inactive BWP.

12. The method of claim 10, wherein the configuration information indicates to perform the CSI measurement on the inactive BWP without a gap on an active BWP of the UE when the gapless CSI measurement capability indicates that the UE is capable of performing the CSI measurement on the inactive BWP without the gap on the active BWP of the UE.

13. The method of claim 10, wherein the configuration information indicates to perform the reference signal transmission on the inactive BWP without a gap on an active BWP of the UE when the gapless reference signal transmission capability indicates that the UE is capable of performing the reference signal transmission on the inactive BWP without the gap on the active BWP of the UE.

14. The method of claim 10, wherein the configuration information indicates to perform the CSI measurement on the inactive BWP with a gap on an active BWP of the UE when the gapless CSI measurement capability indicates that the UE is not capable of performing the CSI measurement on the inactive BWP without the gap on the active BWP of the UE.

15. The method of claim 10, wherein an uplink grant or acknowledgment (ACK)/negative ACK (HACK) is not configured on an active BWP of the UE in a symbol associated with the reference signal transmission when the gapless reference signal transmission capability indicates that the UE is not capable of performing the reference signal transmission on the inactive BWP without a gap on the active BWP of the UE.

16. The method of claim 10, further comprising:
configuring the UE to switch the inactive BWP to an active BWP of the UE.

17. The method of claim 10, wherein the one or more capabilities are based at least in part on a tunable bandwidth of the UE.

18. A user equipment (UE) for wireless communication, comprising:
a memory; and
one or more processors operatively coupled to the memory, the memory and the one or more processors configured to:
transmit information identifying one or more capabilities of the UE in connection with an inactive bandwidth part (BWP) of the UE, wherein the one or more capabilities include at least one of a gapless channel state information (CSI) measurement capability or a gapless reference signal transmission capability; and
perform at least one of a CSI measurement or a reference signal transmission on the inactive BWP in accordance with the one or more capabilities.

19. The UE of claim 18, the memory and the one or more processors further configured to:
receive configuration information for performing the CSI measurement on the inactive BWP in accordance with the one or more capabilities.

20. The UE of claim 18, the memory and the one or more processors further configured to:
transmit, on an active BWP of the UE, a CSI report based at least in part on the CSI measurement on the inactive BWP.

21. The UE of claim 18, the memory and the one or more processors further configured to:
receive configuration information for performing the reference signal transmission on the inactive BWP in accordance with the one or more capabilities.

22. The UE of claim 18, wherein the memory and the one or more processors configured to perform at least one of the CSI measurement or the reference signal transmission on the inactive BWP in accordance with the one or more capabilities comprises the memory and the one or more processors configured to:
perform the CSI measurement on the inactive BWP without a gap on an active BWP of the UE when the gapless CSI measurement capability indicates that the UE is capable of performing the CSI measurement on the inactive BWP without the gap on the active BWP of the UE.

23. The UE of claim 18, wherein the memory and the one or more processors configured to perform at least one of the CSI measurement or the reference signal transmission on the inactive BWP in accordance with the one or more capabilities comprises the memory and the one or more processors configured to:
perform the reference signal transmission on the inactive BWP without a gap on an active BWP of the UE when the gapless reference signal transmission capability indicates that the UE is capable of performing the reference signal transmission on the inactive BWP without the gap on the active BWP of the UE.

24. The UE of claim 18, wherein the memory and the one or more processors configured to perform at least one of the CSI measurement or the reference signal transmission on the inactive BWP in accordance with the one or more capabilities comprises the memory and the one or more processors configured to:
perform the CSI measurement on the inactive BWP with a gap on an active BWP of the UE when the gapless CSI measurement capability indicates that the UE is not capable of performing the CSI measurement on the inactive BWP without the gap on the active BWP of the UE.

25. The UE of claim 18, wherein the memory and the one or more processors configured to perform at least one of the CSI measurement or the reference signal transmission on the inactive BWP in accordance with the one or more capabilities comprises the memory and the one or more processors configured to:
perform the reference signal transmission on the inactive BWP with a gap on an active BWP of the UE when the gapless reference signal transmission capability indicates that the UE is not capable of performing the reference signal transmission on the inactive BWP without the gap on the active BWP of the UE.

26. The UE of claim 18, wherein the one or more capabilities are based at least in part on a tunable bandwidth of the UE.

27. A base station for wireless communication, comprising:
a memory; and
one or more processors operatively coupled to the memory, the memory and the one or more processors configured to:
receive information identifying one or more capabilities of a user equipment (UE), wherein the one or more capabilities include at least one of a gapless channel state information (CSI) measurement capability or a gapless reference signal transmission capability; and
transmit configuration information for performing at least one of a CSI measurement or a reference signal transmission on an inactive BWP of the UE in accordance with the one or more capabilities.

28. The base station of claim 27, the memory and the one or more processors are further configured to:
receive, on an active BWP associated with the UE, a CSI report based at least in part on the CSI measurement on the inactive BWP.

29. The base station of claim 27, wherein the configuration information indicates to perform the CSI measurement on the inactive BWP without a gap on an active BWP of the UE when the gapless CSI measurement capability indicates that the UE is capable of performing the CSI measurement on the inactive BWP without the gap on the active BWP of the UE.

30. The base station of claim 27, wherein the configuration information indicates to perform the reference signal transmission on the inactive BWP without a gap on an active BWP of the UE when the gapless reference signal transmission capability indicates that the UE is capable of performing the reference signal transmission on the inactive BWP without the gap on the active BWP of the UE.
